(19) United States
(12) Patent Application Publication
(10) Pub. No.: US 2023/0218136 A1
(43) Pub. Date: Jul. 13, 2023

(54) Ceiling Fan Cleaning Device

(71) Applicant: Chad Agnew, Kingwood, TX (US)

(72) Inventor: Chad Agnew, Kingwood, TX (US)

(21) Appl. No.: 18/064,343

(22) Filed: Dec. 12, 2022

Related U.S. Application Data
(60) Provisional application No. 63/299,062, filed on Jan. 13, 2022.

(51) Int. Cl. A47L 13/16; A47L 13/38

(52) U.S. Cl. CPC A47L 13/16; A47L 13/38

(57) ABSTRACT

The present invention relates to a ceiling fan cleaning device primarily comprised of an outer housing, a first end, further comprised of a handle, and a second end preferably comprised of a first planar member and a second planar member. Both planar members are comprised of a fastener that can be used to secure a dusting pad to/around each planar member and are further angled to better contact the top surface and a bottom surface of a ceiling fan blade. The device can be manipulated such that the blade of a ceiling fan is placed between both planar members, wherein the device can be moved back and forth to easily clean the fan blade.

### CROSS REFERENCE TO RELATED APPLICATION

The present application claims priority to, and the benefit of, U.S. Provisional Application No. 63/299,062, which was filed on Jan. 13, 2022, and is incorporated herein by reference in its entirety.

### FIELD OF THE INVENTION

The present invention relates generally to the field of cleaning devices. More specifically, the present invention relates to a ceiling fan cleaning device primarily comprised of an outer housing, a first end, further comprised of a handle, and a second end preferably comprised of a first planar member and a second planar member. Both planar members are comprised of a fastener that can be used to secure a dusting pad to/around each planar member and are further angled to better contact the top surface and a bottom surface of a ceiling fan blade. The device can be manipulated such that the blade of a ceiling fan is placed between both planar members, wherein the device can be moved back and forth to easily clean the fan blade. Accordingly, the present disclosure makes specific reference thereto. Nonetheless, it is to be appreciated that aspects of the present invention are also equally applicable to other like applications, devices, and methods of manufacture.

### BACKGROUND

Many homes have at least one ceiling fan, wherein most residential ceiling heights place the fan out of reach from residents of the home. Over time, the blades of a ceiling fan accumulate dust or other debris. Many individuals, especially those allergic to dust, must regularly clean the blades of a ceiling fan to prevent a build-up of dust and debris, which can irritate allergies and make breathing difficult. However, because of the typical height of a ceiling fan, a stepladder is often required to clean the blades of the fan which exposes the user to the risk of falling and injuring themselves. Alternatively, a user may use a duster or other device to attempt to clean the blades of a ceiling fan without the use of a stepladder. However, said devices are often ineffective due to the lack of pressure said devices can exert on the ceiling fan blade. As a result, such devices do not adequately remove dust and other debris from ceiling fan blades.

Therefore, there exists a long-felt need in the art for a ceiling fan cleaning device that can more thoroughly and easily clean the blades of a ceiling fan than existing devices known in the art. There also exists a long-felt need in the art for an extendable ceiling fan double cleaning pad device that simultaneously cleans the top and bottom surfaces of a ceiling fan blade. Further, there exists a long-felt need in the art for an extendable ceiling fan double cleaning pad device that simultaneously cleans the top and bottom surfaces of a ceiling fan blade, wherein the device creates adequate pressure to easily remove dust and debris from the surfaces of the fan blade.

The subject matter disclosed and claimed herein, in one embodiment thereof, comprises a ceiling fan cleaning device. The device is primarily comprised of an outer housing, a first end, further comprised of a handle, and a second end preferably comprised of a first planar member and a second planar member. Both planar members are comprised of a fastener that can be used to secure a dusting pad to/around each planar member. Each planar member is further angled to better contact the top surface and a bottom surface of a ceiling fan blade. The device can be manipulated such that the blade of a ceiling fan is placed between both planar members, wherein the device can be moved back and forth to easily clean the fan blade.

In this manner, the ceiling fan cleaning device of the present invention accomplishes all of the foregoing objectives and provides a ceiling fan cleaning device that can more thoroughly and easily clean the blades of a ceiling fan than existing devices known in the art. Further, during use, the device simultaneously cleans the top and bottom surfaces of a ceiling fan blade. While doing so, the device creates adequate pressure to easily remove dust and debris from the surfaces of the fan blade.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ceiling fan cleaning device. The device is primarily comprised of an outer housing, a first end, further comprised of a handle, and a second end preferably comprised of a first planar member and a second planar member. In the preferred embodiment, all components of the device are manufactured from a durable metal material or a rigid plastic material. The outer housing is further preferably oblong or cylindrical in shape to prevent the housing from rotating when contacting a fan blade.

The first end is comprised of at least one handle. The handle may be textured to provide a non-slip gripping surface for a user. The handle may also be contoured to fit the hand of the user. Similarly, the outer housing may also be comprised of at least one grip area. The grip area may be textured to provide a non-slip gripping surface for a user. The grip may also be contoured to fit the hand of the user.

The handle is fixedly connected to at least one inner shaft within the outer housing. The inner shaft may be telescoping such that it can increase and decrease in length as needed during use. In another embodiment, the inner shaft is of a fixed length or has a plurality of shafts nested within one another.

The second end of the housing is further comprised of at least one first planar member that preferably attaches to and/or around the second end in a removable (i.e., slip-on) fashion. The first planar member and second planar member are preferably generally rectangular in shape. The first planar member and second planar member may further be comprised of at least one fastener that is preferably a spring-loaded, wire-fork clamp. In the preferred embodiment, the fastener of the first member is located on the top surface of the first member and the fastener of the second planar member is located on the bottom surface of the second planar member such that the placement of the fasteners does not interfere with the dusting ability of the device. The fasteners further allow at least one dusting pad to attach to each member by being secured on or around the planar members.

In another embodiment, the device has no members and is comprised of at least one dusting head fixedly attached to the inner shaft. The dusting pads and dusting head may be any type and style of dusting pad or dusting head known in the art. Both the pad and the head may be scented to provide a pleasant aroma while cleaning.

The device is also comprised of a method of using the device. First, the inner shaft is pushed upward and away from the second end of the housing such that distance is created between the first planar member and the second planar member. Then, a dusting pad is placed on and/or over each member and is secured to each member via the fastener of each member. The inner shaft can then be extended in length as needed or the device can be raised upward until a ceiling fan blade is positioned between (but not touching) the planar members. Next, the inner shaft can be pulled downward toward the second end of the housing using the handle such that the bottom surface of the second planar member moves downward with the movement of the inner shaft. In doing so, the distance initially created between the members is closed such that the top surface of the first planar member contacts the bottom surface of the fan blade and the bottom surface of the second planar member contacts the top surface of the fan blade. Then, a user can move the device back and forth along the fan blade 10 to dust the fan blade while the blade is secured within the members.

Accordingly, the ceiling fan cleaning device of the present invention is particularly advantageous as it can more thoroughly and easily clean the blades of a ceiling fan than existing devices known in the art. Further, the device simultaneously cleans the top and bottom surfaces of a ceiling fan blade while creating adequate pressure to easily remove dust and debris from the surfaces of the fan blade. In this manner, the ceiling fan cleaning device overcomes the limitations of existing cleaning devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ceiling fan cleaning device of the present invention in accordance with the disclosed architecture;

FIG. 2 illustrates a perspective view of one potential embodiment of a ceiling fan cleaning device of the present invention with a telescoping inner shaft in accordance with the disclosed architecture;

FIG. 3 illustrates a perspective view of one potential embodiment of a ceiling fan cleaning device of the present invention wherein the fasteners of the first and second planar members are visible in accordance with the disclosed architecture;

FIG. 4 illustrates a perspective view of one potential embodiment of a ceiling fan cleaning device of the present invention with dusting pads attached in accordance with the disclosed architecture;

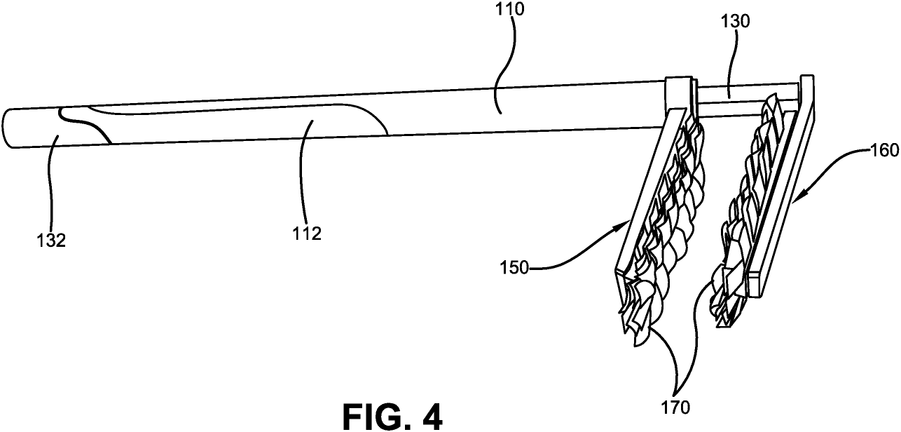

FIG. 5 illustrates an enhanced perspective view of one potential embodiment of a ceiling fan cleaning device of the present invention with dusting pads attached and while cleaning a ceiling fan blade in accordance with the disclosed architecture;

FIG. 6 illustrates a perspective view of one potential embodiment of a ceiling fan cleaning device of the present invention with a dusting head in accordance with the disclosed architecture;

FIG. 7 illustrates a flowchart of one potential method of using one potential embodiment of a ceiling fan cleaning device of the present invention in accordance with the disclosed architecture; and

FIG. 8 illustrates a perspective view of one potential embodiment of a ceiling fan cleaning device of the present invention while being used by a user to clean a ceiling fan in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a ceiling fan cleaning device that can more thoroughly and easily clean the blades of a ceiling fan than existing devices known in the art. There also exists a long-felt need in the art for an extendable ceiling fan double cleaning pad device that simultaneously cleans the top and bottom surfaces of a ceiling fan blade. Further, there exists a long-felt need in the art for an extendable ceiling fan double cleaning pad device that simultaneously cleans the top and bottom surfaces of a ceiling fan blade, wherein the device creates adequate pressure to easily remove dust and debris from the surfaces of the fan blade.

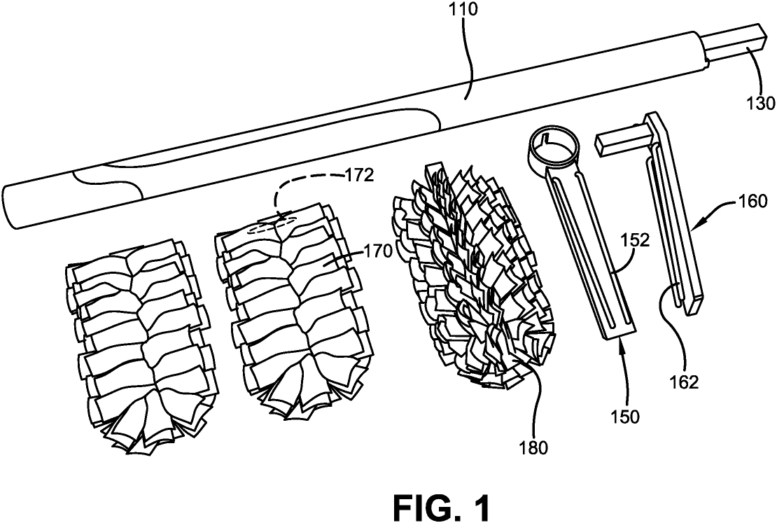

Referring initially to the drawings, FIG. 1 illustrates a perspective view of one potential embodiment of a ceiling fan cleaning device 100 of the present invention in accordance with the disclosed architecture. The device 100 is primarily comprised of an outer housing 110, a first end 120, further comprised of a handle 132, and a second end 140 preferably comprised of a first planar member 150 and a second planar member 160. In the preferred embodiment, all components of the device 100, unless otherwise stated herein, are manufactured from a durable metal material such as, but not limited to, stainless steel or a rigid plastic material such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The outer housing 110 is further preferably oblong or cylindrical in shape to prevent the housing 110 from rotating when contacting a fan blade 10.

The first end 120 is comprised of at least one handle 132. The handle 132 is preferably manufactured from a rubber material such as, but not limited to: natural rubbers, neoprene rubber elastomer, silicone rubber elastomer, ethylene propylene diene monomer rubber, butyl rubber, nitrile rubber, buna-n rubber, styrene-butadiene rubber elastomers, Viton rubber elastomer, diaphragm rubber, thermoplastic rubber, etc. The handle 132 may be textured to provide a non-slip gripping surface for a user. The handle 132 may also be contoured to fit the hand of the user.

The outer housing 110 may also be comprised of at least one grip area 112 preferably manufactured from a rubber material such as, but not limited to: natural rubbers, neoprene rubber elastomer, silicone rubber elastomer, ethylene propylene diene monomer rubber, butyl rubber, nitrile rubber, buna-n rubber, styrene-butadiene rubber elastomers, Viton rubber elastomer, diaphragm rubber, thermoplastic rubber, etc. The grip 112 may be textured to provide a non-slip gripping surface for a user. The grip 112 may also be contoured to fit the hand of the user. The handle 132 and grip 112 allow a user to easily maneuver the device 100 during use.

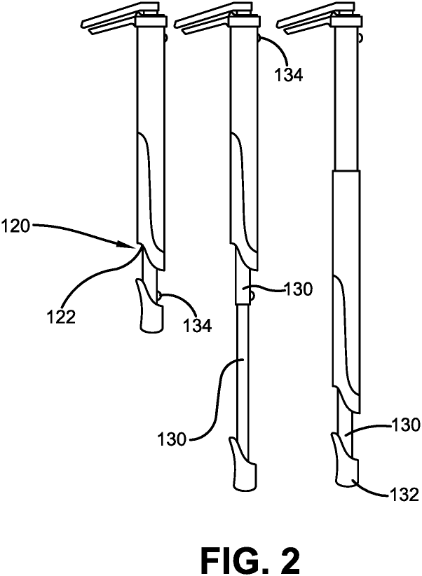

FIG. 2 illustrates a perspective view of one potential embodiment of a ceiling fan cleaning device 100 of the present invention with a telescoping inner shaft 130 in accordance with the disclosed architecture. The handle 132 is fixedly connected to at least one inner shaft 130 within the outer housing 110. The inner shaft 130 enters the housing 110 via at least one continuous opening 122 that extends between the first end 120 and the second end 140 of the housing 110. In one embodiment, the inner shaft 130 is telescoping such that it can increase and decrease in length as needed during use. In another embodiment, the inner shaft 130 is of a fixed length. In a further embodiment, the device 100 has a plurality of shafts 130 nested within one another. The shafts 130 may further be locked and unlocked in position in a nested or telescoping embodiment using at least one button 134 found on the shaft 130, housing 110, or handle 132.

The second end 140 of the housing 110 is further comprised of at least one first planar member 150. The member 150 preferably attaches to and/or around the second end 140 in a removable (i.e., slip-on) fashion. In another embodiment, the member 150 is fixedly attached to and/or around the second end 140.

The first planar member 150 and second planar member 160 are preferably generally rectangular in shape. The first planar member 150 preferably forms a 70-degree angle relative to the outer housing 110. The second planar member 160 preferably forms a 70-degree angle relative to the inner shaft 130. The 70-degree angle matches the angle of most fan blades 10 to allow the members 150,160 to properly contact the top surface 12 and bottom surface 14 of the fan blade 10 during use. However, the angle formed by each member 150,160 may differ in various embodiments to accommodate fan blades of differing angles.

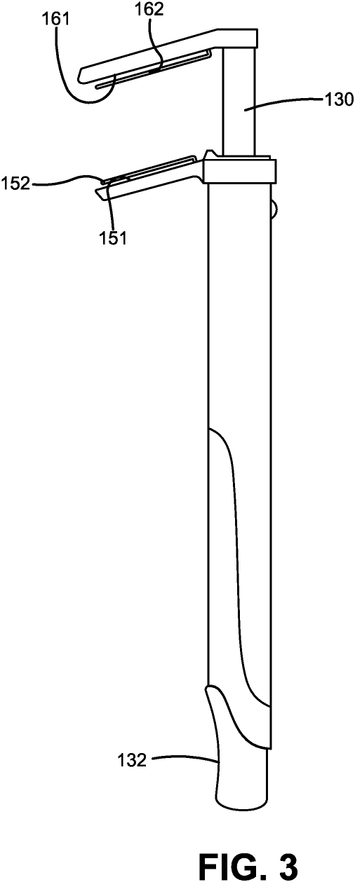

The first planar member 150 and second planar member 160 may further be comprised of at least one fastener 152,162, as seen in FIG. 3. In the preferred embodiment, the fastener 152,162 is a spring-loaded, wire-fork clamp. However, the fastener 152,162 may be any fastener type known in the art such as, but not limited to: adhesive, hook and loop, magnet, etc. In the preferred embodiment, the fastener 152 of the first member 150 is located on the top surface 151 of the first member 150 and the fastener 162 of the second planar member 160 is located on the bottom surface 161 of the second planar member 160. In this manner, the placement of the fasteners 152,162 do not interfere with the dusting ability of the device 100 and do not contact a top surface 12 or bottom surface 14 of a fan blade 10 while the device 100 is being used.

The fasteners 152,162 further allow at least one dusting pad 170 to attach to each member 150,160. In one embodiment, the fasteners 152,162 secure the dusting pad 170 to a surface 151,161 of each member 150,160. In a different embodiment, each member 150,160 is placed inside a dusting pad 170 via at least one opening 172 of the dusting pad 170, wherein each fastener 152,162 then secures the dusting pad 170 around each member 150,160.

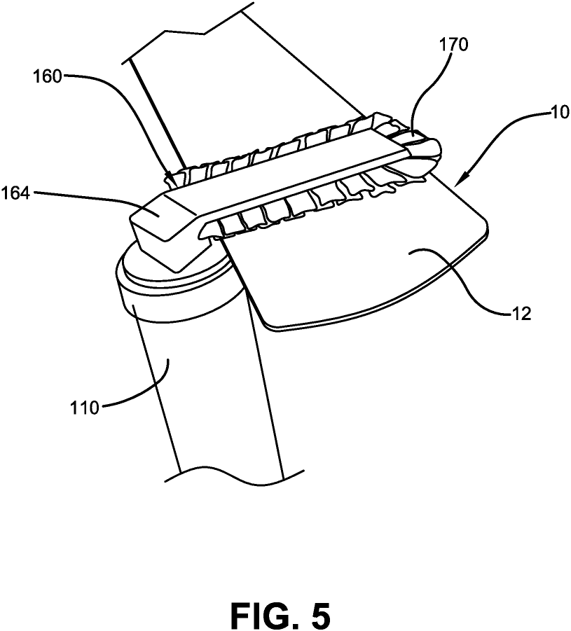

FIG. 5 illustrates an enhanced perspective view of one potential embodiment of a ceiling fan cleaning device of the present invention with dusting pads 170 attached while cleaning a ceiling fan blade in accordance with the disclosed architecture. The second planar member 160 is preferably fixedly attached to a portion of the inner shaft 130 opposite the handle 132. More specifically, the planar member 160 attaches to the inner shaft 130 via a square base 164 of the member 160. The square base 164 prevents rotation of the member 160 when the member 160 contacts a fan blade 10 during use.

In another embodiment, the device 100 has no members 150, 160 and is comprised of at least one dusting head 180 fixedly attached to the inner shaft 130. However, another embodiment of the device 100 may feature the device 100 as described but be additionally comprised of at least one additional inner shaft 130 with a handle 132, at least one button 134, and at least one dusting head 180. In this manner, an inner shaft 130 with planar members 150,160 and an inner shaft 130 with a dusting head 180 can be interchangeably used with one outer housing 110.

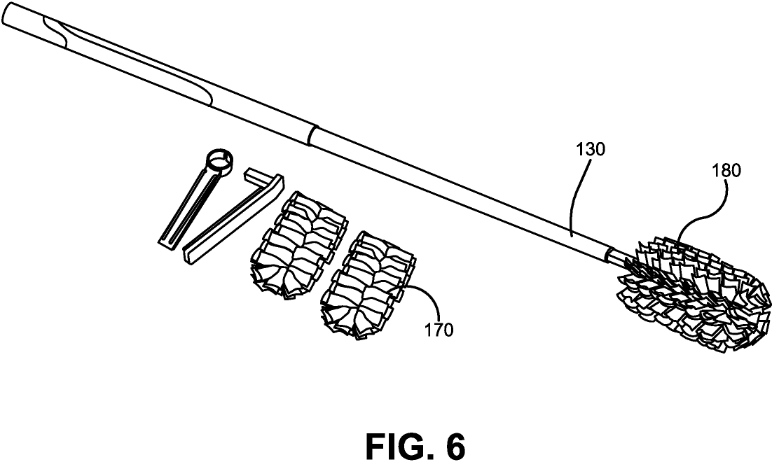

As further seen in FIG. 6, the dusting pads 170 and dusting head 180 may be any type and style of dusting pad or dusting head 180 known in the art. Both the pad 170 and the head 180 may be scented to provide a pleasant aroma while cleaning. The dusting head 180 may further be made from a natural or artificial bristled material.

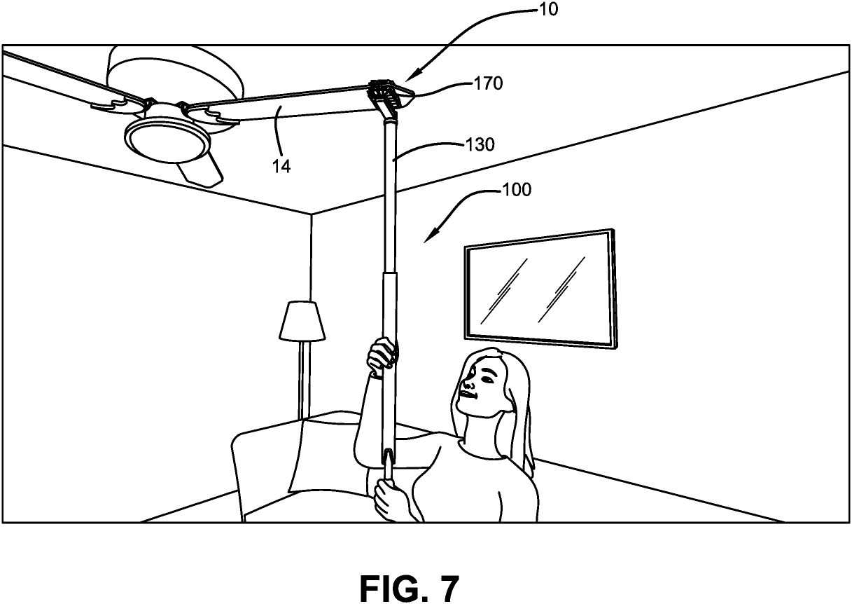

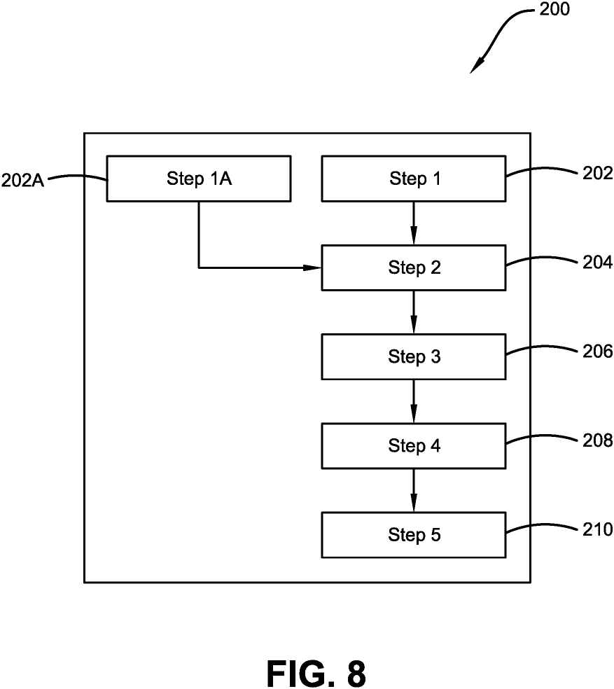

FIG. 7 illustrates a flowchart of one potential method 200 of using one potential embodiment of a ceiling fan cleaning device 100 of the present invention in accordance with the disclosed architecture. The device 100 is also comprised of a method 200 of using the device. First, the inner shaft 130 is pushed upward and away from the second end 140 of the housing 110 using the handle 132 to create distance between the first planar member 150 and the second planar member 160 [Step 202]. Then, a dusting pad 170 is placed on and/or over each member 150, 160 and is secured to each member 150,160 via the fastener 152,162 of each member 150,160 [Step 204]. Next, the inner shaft 130 can further be extended in length as needed or the device 100 can be raised upward until a ceiling fan blade 10 is positioned between (but not touching) the planar members 150,160 [Step 206]. Then, the inner shaft 130 can be pulled downwards towards the second end 140 of the housing 110 using the handle 132 such that the bottom surface 161 of the second planar member 160 moves downward with the movement of the inner shaft 130 [Step 208]. This step [Step 208] effectively closes the distance initially created between the members 150,160 such that the top surface 151 of the first planar member 150 contacts the bottom surface 14 of the fan blade 10 and the bottom surface 161 of the second planar member 160 contacts the top surface 12 of the fan blade 10. Because each member 150,160 has a dusting pad 170 attached, a user can simply move the device 100 back and forth along the fan blade 10 to dust the fan blade 10 while the blade 10 is secured within the members 150, 160, as seen in FIG. 8 [Step 210]. In an embodiment of the device 100 with a dusting head 180, the only step required is extending the length of the inner shaft 130 upward and away from the housing 110 toward a fan blade 10 as needed [Step 202A].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ceiling fan cleaning device” and “device” are interchangeable and refer to the ceiling fan cleaning device 100 of the present invention.

Notwithstanding the foregoing, the ceiling fan cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ceiling fan cleaning device 100 as shown in the FIGS. are for illustrative purposes only, and that many other sizes and shapes of the ceiling fan cleaning device 100 are well within the scope of the present disclosure. Although the dimensions of the ceiling fan cleaning device 100 are important design parameters for user convenience, the ceiling fan cleaning device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ceiling fan cleaning device comprising:
an outer housing;
an inner shaft comprised of a handle;
a first planar member;
a second planar member; and
a dusting pad.

2. The ceiling fan cleaning device of claim 1, wherein the inner shaft is positioned within the outer housing.

3. The ceiling fan cleaning device of claim 1, wherein the first planar member is fixedly attached to a second end of the outer housing.

4. The ceiling fan cleaning device of claim 1, wherein the handle has a texture.

5. A ceiling fan cleaning device comprising:
an outer housing;
a button;
an inner shaft comprised of a handle;
a first planar member;
a second planar member; and
a dusting pad.

6. The ceiling fan cleaning device of claim 5, wherein the first planar member forms a 70-degree angle relative to the outer housing.

7. The ceiling fan cleaning device of claim 5, wherein the second planar member forms a 70-degree angle relative to the outer housing.

8. The ceiling fan cleaning device of claim 5, wherein a first fastener is positioned on the first planar member and a second fastener is positioned on the second planar member.

9. The ceiling fan cleaning device of claim 8, wherein the first fastener of the first planar member is positioned on a top surface of the first planar member and the second fastener of the second planar member is positioned on a bottom surface of the second planar member.

10. The ceiling fan cleaning device of claim 9, wherein each of the first and second fasteners is a spring-loaded wire fork clamp.

11. The ceiling fan cleaning device of claim 5, wherein the dusting pad is comprised of an opening.

12. The ceiling fan cleaning device of claim 5, wherein the second planar member is further comprised of a base.

13. The ceiling fan cleaning device of claim 12, wherein the base prevents a rotation of the second planar member.

14. The ceiling fan cleaning device of claim 5 further comprising a dusting head.

15. The ceiling fan cleaning device of claim 14, wherein the outer housing is further comprised of a grip area.

16. The ceiling fan cleaning device of claim 15, wherein the grip area is a contoured grip area.

17. The ceiling fan cleaning device of claim 5, wherein the inner shaft is a telescopic shaft.

18. The ceiling fan cleaning device of claim 17, wherein the button locks a position of the inner shaft.

19. The ceiling fan cleaning device of claim 5, wherein the outer housing comprises an oblong shape.

20. A method of using a ceiling fan cleaning device, the method comprising the steps of:
pushing an inner shaft of the ceiling fan cleaning device upwards and away from a second end of a housing of the ceiling fan cleaning device using a handle of the inner shaft to create a distance between a first planar member and a second planar member of the ceiling fan cleaning device;
placing a first dusting pad on the first planar member and placing a second dusting pad on the second planar member;
securing the first dusting pad to the first planar member and the second dusting pad to the second planar member using a fastener located on the first planar member and a fastener located on the second planar member;
pulling the inner shaft downwards towards a second end of the housing using the handle such that a bottom surface of the second planar member moves downwards with the movement of the inner shaft; and
moving the ceiling fan cleaning device back and forth along a fan blade to dust the fan blade while the fan blade is secured within the first planar member and the second planar member.
